(19) United States
(12) Patent Application Publication
(10) Pub. No.: US 2025/0328912 A1
(43) Pub. Date: Oct. 23, 2025

(54) SYSTEM AND METHOD FOR PROCESSING RETAIL RETURNS

(71) Applicant: TARGET BRANDS, INC., Minneapolis, MN (US)

(72) Inventors: Mary J. OSTER, Blaine, MN (US); Rachel K. DERAAS, Apple Valley, MN (US); Kayla A. BYERS, Bloomington, MN (US); Kimberle J. WILES, Andover, MN (US); Michael JUAREZ-SWEENEY, Saint Paul, MN (US); Deborah J. WISWELL, Roseville, MN (US); Mithun RAVINDRANATH, Cottage Grove, MN (US); Deepasri NARASIMHAMURTHY, Bengaluru (IN)

(21) Appl. No.: 18/643,501

(22) Filed: Apr. 23, 2024

(51) Int. Cl. G06Q 20/40; G06Q 30/0207

(52) U.S. Cl. CPC G06Q 20/407; G06Q 30/0207

(57) ABSTRACT

A computer implemented method for retail sales includes analyzing coupon information associated with one or more items in a sales transaction, applying a portion of the coupon to the one or more items, and associating the one or more items with the sales transaction in a database as an item entry. The method further includes receiving a return request, retrieving the item entry based on the return request, and determining a refund based on the item entry, including the portion of the coupon.

### BACKGROUND

Product manufacturers often issue coupons to encourage consumers to purchase various items. When consumers utilize manufacturer coupons at a retailer, the manufacturer generally reimburses the retailer for the amount of the coupon and the retailer tenders the coupon amount to the customer at checkout (receiving the reimbursement at a later day from the manufacturer). However, upon return of an item purchased with a manufacturer coupon, there is often no way to determine that a coupon was used during purchase, which can result in fraud as people may use a coupon to purchase an item, receive a price reduction at checkout, and then return the item to receive a refund for the full price, pocketing the difference between the full price and the reduced price. Accordingly, the customer is refunded for the retail price including the manufacturer coupon value, costing the retailer. Further, in some instances, the returned product may also be damaged or otherwise not appropriate for resale, leading to additional losses for the retailer.

### SUMMARY

A computer implemented method for retail sales includes analyzing coupon information associated with one or more items in a sales transaction, applying a portion of the coupon to the one or more items, and associating the one or more items with the sales transaction in a database as an item entry. The method further includes receiving a return request, retrieving the item entry based on the return request, and determining a refund based on the item entry, including the portion of the coupon.

In some examples, analyzing the coupon information includes determining the portion of the coupon to apply to the one or more items.

In some examples, the one or more items includes a plurality of items, where the coupon information includes an indicator that the coupon is applicable to each of the plurality of the one or more items in the sales transaction.

In some examples, applying the portion of the coupon to the one or more items includes applying the portion of the coupon to each of the plurality of the one or more items.

In some examples, the refund is a purchase price of the one or more items less the portion of the coupon applied to the one or more items.

In some examples, the method further includes refunding the coupon amount to a manufacturer associated with a coupon.

In some examples, the method further includes validating, using the coupon information, that the coupon can be applied to the one or more items in the sales transaction.

A transaction management system includes an interface in communication with a point of sale system associated with a retailer, where the interface is configured to receive data associated with a sales transaction and a coupon applied during the sales transaction. The transaction management system further includes a sales transaction database configured to store an item entry, where the item entry includes at least one item associated with the sales transaction and the coupon and a return validation system in communication with a return system associated with the retailer, where the return validation system is configured to determine a refund based on the item entry stored in the sales transaction database.

In some examples, the transaction management system further includes a sale validation system configured to analyze the data associated with the coupon and apply the coupon to the at least one item during the sales transaction.

In some examples, the refund is a purchase price of the at least one item less a value of the coupon applied to the at least one item.

In some examples, the transaction management system further includes a settlement system in communication with a manufacturer system, where the settlement system is configured to refund a value of the coupon to the manufacturer system responsive to determining the refund.

In some examples, the return validation system is further configured to communicate the refund to the return system.

In some examples, the at least one item includes a plurality of items, where the item entry includes an indicator that a portion of the coupon was applied to each of the plurality of items during the sales transaction.

In some examples, the refund is based on the portion of the coupon applied to an item of the plurality of items.

One or more non-transitory computer readable media are encoded with instructions which, when executed by one or more processors, cause the one or more processors to receive, from a point of sale system associated with a retailer, data associated with a sales transaction and a coupon applied during the sales transaction. The instructions further cause the one or more processors to store an item entry, where the item entry comprises an item purchased during the sales transaction and the coupon, determine a refund based on the item entry stored in the sales database, and communicate the refund to a return system associated with the retailer.

In some examples, the refund is determined responsive to receiving a refund request for the item from the return system.

In some examples, a portion of a value of the coupon is applied to each of a plurality of items during the sales transaction.

In some examples, the refund is determined further based on the portion of the value of the coupon applied to an item of the plurality of items.

In some examples, the instructions further cause the processors to retrieve the item entry from the sales database based on return request information received from the return system.

In some examples, the instructions further cause the processors to provide a refund to a manufacturer system of a value of the coupon responsive to determining the refund.

Additional embodiments and features are set forth in part in the description that follows, and will become apparent to those skilled in the art upon examination of the specification and may be learned by the practice of the disclosed subject matter. A further understanding of the nature and advantages of the present disclosure may be realized by reference to the remaining portions of the specification and the drawings, which form a part of this disclosure. One of skill in the art will understand that each of the various aspects and features of the disclosure may advantageously be used separately in some instances, or in combination with other aspects and features of the disclosure in other instances.

### BRIEF DESCRIPTION OF THE DRAWINGS

The description will be more fully understood with reference to the following figures in which components are not drawn to scale, which are presented as various examples of the present disclosure and should not be construed as a complete recitation of the scope of the disclosure, characterized in that:

FIG. 1 illustrates an example system including user devices in communication with an transaction management system, in accordance with various examples described herein.

FIG. 2 illustrates a schematic diagram of an example transaction system and components in communication with the transaction management system.

FIG. 3 is a schematic diagram of an example computer system implementing various embodiments in the examples described herein.

FIG. 4 is a flow diagram of steps for determining a refund for an item purchased with a coupon.

FIG. 5 is a flow diagram of steps for storing coupon information associated with a sales transaction.

FIG. 6 is a flow diagram of steps for determining a refund for an item based on stored coupon information associated with a sales transaction.

### DETAILED DESCRIPTION

Manufacturers often issue coupons to encourage customers to purchase specific items, and such coupons may be utilized at various retailers. Conventionally, when a customer utilizes a manufacturer coupon to receive a tender towards a purchased item, the coupon is entered into the system of the retailer and the customer immediately receives the tender (e.g., a reduction in price) on the item purchased with the coupon. The coupon itself (either a paper coupon or a digital file including information about the coupon) is then sent to a manufacturer system so that the retailer may be reimbursed for the coupon amount. However, when a customer returns an item purchased using a manufacturer coupon in such a manner, currently it is not feasible to process a return without refunding the customer the amount of the coupon. Due to this, often retailers will refund customers the full price of the product and the customer will receive a windfall amounting to the difference between the full price and the price paid with the coupon. Such refunds can cost retailers significant amounts of money.

Further, many manufacturer coupons provide a price reduction (e.g., a tender towards purchase) upon purchasing a number of items. For example, a manufacturer coupon may provide for one dollar off when purchasing ten of a particular item. Conventionally, the coupon would be applied such that the dollar tender is applied to one item in the purchase (e.g., nine items are the regular price and the tenth item is free). Upon return of one item, the customer would be given the full undiscounted price in cash, i.e., the “return” is processed on one of the nine items rather than the tenth or applying the tender across the set. This practice is required due to the back end coupon processing systems and cost retailers money and not accurately reflecting the tender provided by the coupon.

The transaction management system described herein stores purchase information including coupons applied to items within a purchase. The stored information can be accessed both at purchase of an item and upon return of an item. When a return of an item purchased with a coupon is initiated, the stored purchase information can be utilized to determine whether an item was purchased using a coupon. The coupon amount can then be returned to the manufacturer, with the customer receiving a refund of the actual amount paid, helping to prevent “windfalls” to the customer. Further, the transaction management system allows manufacturer coupons to be prorated over multiple items. For example, where a manufacturer coupon provides a dollar tender toward purchase on the purchase of ten items, the system may prorate the coupon such that a ten-cent tender is applied to each item. Upon return of one item, ten cents is returned to the manufacturer and the customer is refunded for the prorated purchase price. This helps to prevent fraud, as well as reduce losses by retailers in the purchase and return of products associated with a manufacturer coupon, while still allowing customers to enjoy the benefit of the price reductions offered by manufactures. Conventional software systems and databases for retailers and manufactures do not allow the tracking and application of applied manufacturer (e.g., third party) coupons at both check out and a return stage, while also enabling a real time price reduction and tender to be provided to the customer at checkout.

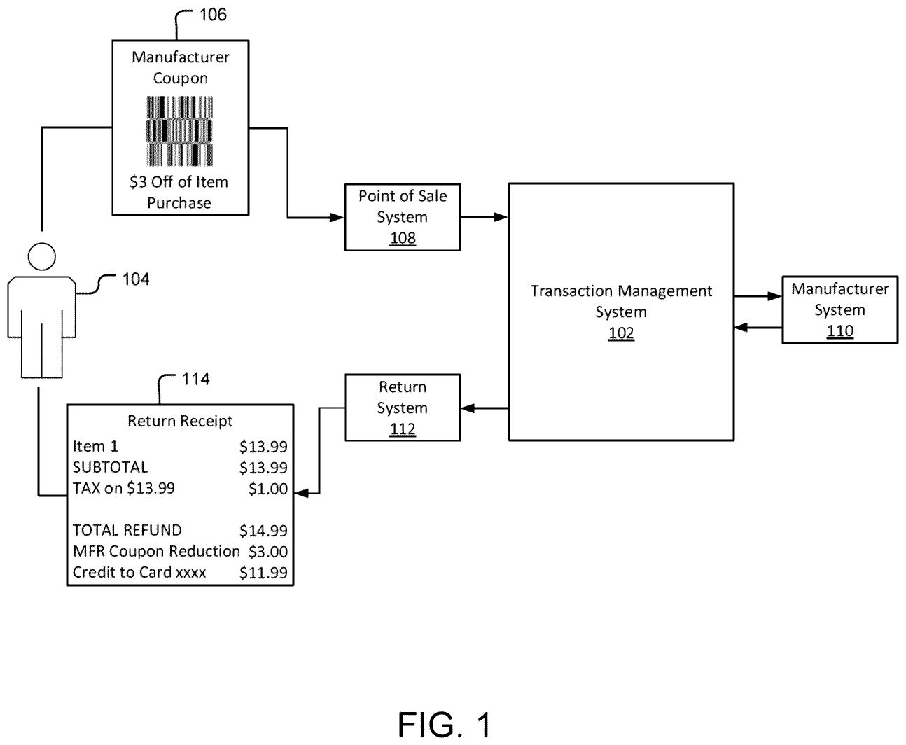

Turning to the drawings, FIG. 1 illustrates an example system including user devices in communication with a transaction management system, in accordance with various examples described herein. Generally, a customer 104 may make a purchase using a manufacturer coupon 106 at a point of sale system 108. The point of sale system 108 may communicate with the transaction management system 102 to process the sale, including by storing item information associated with an item purchased by the customer using the coupon at a database of the transaction management system 102. The transaction management system 102 may further communicate with a manufacturer system 110 to process the transaction including the coupon. The customer may further request a return of an item via a return system 112. The return system 112 may communicate with the transaction management system 102 to determine a refund amount to be refunded to the customer 104 based on the item information stored at the transaction management system 102.

The transaction management system 102 generally processes transactions occurring through a point of sale system 108 at a retail location. In some examples, the transaction management system 102 may process transactions from multiple retail locations of the same retailer. Processing transactions may, in various examples, include applying a manufacturer coupon 106 used to purchase an item in the transaction and storing transaction information at a database of the transaction management system 102. Such transaction information may include individual item entries for items purchased in the transaction, and such item entries may include an indication of whether a manufacturer coupon was used in the transaction to purchase the item. Such item entries may be in general, rows in a larger database including a transaction identifier, item identifier, the indication of whether the manufacturer coupon was used to purchase the item, and any additional information stored in the item entry. Accordingly, item entries are associated with both a transaction and the item itself. In some examples, the database may also include transaction entries including pointers or other entries associated with each of the item entries for items in the transaction.

The transaction management system 102 may further process returns initiated via a return system 112 in communication with the transaction management system 102. For example, the transaction management system 102 may access an item entry in a database of the transaction management system 102 to determine whether a coupon was applied to the item at purchase. The transaction management system 102 may perform other functions to process the return, such as verifying that a return is possible (e.g., comparing the return to validation characteristics including that the item is returnable, it is within the a time window for a return, and the like), and generate a return receipt 114. The return receipt 114 generally reflects a refund amount to the customer taking into account any manufacturer coupons applied during the purchase. For example, the return receipt 114 shows the full item price and tax totaling $14.99, with a manufacturer coupon for $3.00 having been applied at purchase. Accordingly, the customer 104 is refunded $11.99, reflecting the amount the customer 104 actually paid for the item at purchase.

The transaction management system 102 may further interface with a manufacturer system 110. For example, on purchase, the transaction management system 102 may interface with the manufacturer system 110 to obtain a reimbursement for the coupon amount from the manufacturer. On return, the transaction management system 102 may communicate with the manufacturer system 110 to return an applied coupon amount to the manufacturer. In various examples, the transaction management system 102 may communicate with multiple manufacturer systems 110. Such interfacing directly with the manufacturer system allows for both real-time tenders (e.g., resulting in effective price reductions) to be provided to the customer while preventing coupon fraud.

The transaction management system 102 may be generally implemented by a computing device or combinations of computing resources in various embodiments. In various examples, the transaction management system 102 may be implemented by one or more servers, cloud computing resources, and/or other computing devices. The transaction management system 102 may, for example, utilize various processing resources to process sales transactions and return transactions. The transaction management system 102 may further include memory and/or storage locations to store program instructions for execution by the processor and various data utilized by the transaction management system 102.

The point of sale system 108 and the return system 112 may be, in various examples, computing devices located at a retail location or separate retail locations. The point of sale system 108 may, in some examples, be a computing device located at a retail location used to complete a sales transaction. In some examples, a point of sale may be a user device completing a sales transaction through a retailer website, application, or the like. The return system 112 may generally be a computing device used to initiate a return of an item and to complete the item return (e.g., by providing a refund to a customer 104, providing a return receipt to a customer 104, and the like). In various examples, the transaction management system 102 may communicate with multiple point of sale systems 108 and return systems 112, which may be located at the same or different retail locations of the retailer.

In various embodiments, the point of sale system 108, the return system 112, and/or other user devices in communication with the transaction management system 102 may be implemented using any number of computing devices. Generally, the sale system 108 and the return system 112 may include one or more processors, such as a central processing unit (CPU) and/or graphics processing unit (GPU). The point of sale system 108 and the return system 112 may generally perform operations by executing executable instructions (e.g., software) using the processor(s).

The transaction management system 102 may generally communicate with other computing systems and/or data stores via a network. The network may be implemented using one or more of various systems and protocols for communications between computing devices. In various embodiments, the network or various portions of the network may be implemented using the Internet, a local area network (LAN), a wide area network (WAN), and/or other networks. In addition to traditional data networking protocols and/or standards including near field communication (NFC), Bluetooth, cellular connections, and the like.

Components of the transaction management system 102 and in communication with the transaction management system 102 are exemplary and may vary in some embodiments. For example, in various embodiments, the transaction management system 102 may be distributed across multiple computing elements, such that components of the transaction management system 102 communicate with one another through a network. Further, in some embodiments, computing resources dedicated to the transaction management system 102 may vary over time based on various factors such as usage of the transaction management system 102. In some embodiments, the transaction management system 102 may communicate with user devices, multiple manufacturer systems, and/or other systems not shown in FIG. 1.

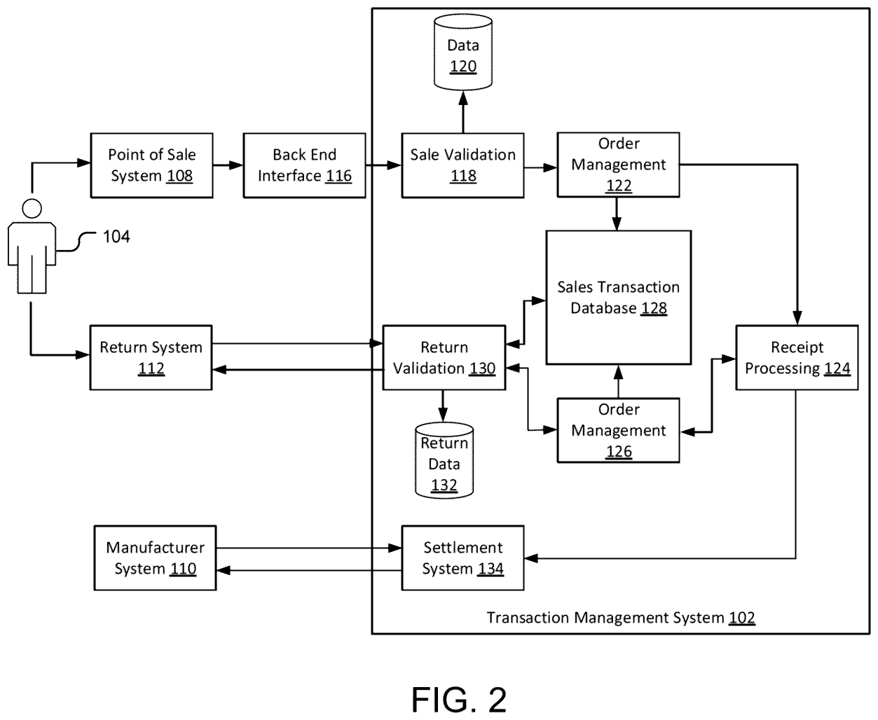

FIG. 2 illustrates a schematic diagram of an example transaction management system 102 and components in communication with the transaction management system 102. The transaction management system 102 generally processes transactions, including sales transactions and return transactions, for a retailer. For example, the transaction management system 102 may be in communication with any number of point of sale systems 108, return systems 112, and/or other hardware utilized by a retailer. In some examples, the transaction management system 102 may also process transactions initiated through a retailer website, mobile application, and the like. For example, the transaction management system 102 may include components to validate sales, generate and process receipts, store transaction data (e.g., item entries for items purchased in a transaction), manage orders, validate returns, generate return receipts, and the like.

In various examples, the transaction management system 102 may include or utilize one or more hosts or combinations of compute resources, which may be located, for example, at one or more servers, cloud computing platforms, computing clusters, and the like. Generally, the transaction management system 102 may be implemented by compute resources at one or more servers, computing devices, and/or across a serverless architecture. The transaction management system 102 may generally be implemented by compute resources including hardware for memory and one or more processors. For example, the transaction management system 102 may utilize or include one or more processors, such as a CPU, GPU, and/or programmable or configurable logic.

The point of sale system 108 and/or the return system 112 may generally communicate with the transaction management system 102 through a back end interface 116. The back end interface may be a tenant of the transaction management system 102 associated with a retail location where the point of sale system 108 is located. Generally, the point of sale system 108 is a computing device including memory storing instructions which, when executed by processors of the point of sale system 108, cause the point of sale system 108 to initiate a sales transaction. Such sales transactions may, in various examples, be processed by the customer paying with cash, credit or debit card, gift card, or other payment methods. In various examples, the point of sale system 108 may include a barcode or other scanner for scanning items purchased in the sales transaction and/or means (e.g., a touchscreen or keyboard) for manual entry of other identifiers of items included in the sales transaction. The point of sale system 108 further captures manufacturer coupon information during the sales transaction (e.g., by scanning a digital or paper coupon, receiving a manual entry of coupon information, or the like). The point of sale system 108 then communicates sales transaction data and individual item data to the transaction management system 102 through the back end interface 116. Sales transaction data may include, in various examples, date and time of the transaction, location of the transaction (e.g., retail location, online transaction, or the like), customer identifier, method of payment (e.g., credit card information), payment amount, and/or additional information about the transaction. Individual item data may include price, item identifier, return status (e.g., whether the item is returnable), coupon information (e.g., whether a manufacturer or other coupon was applied to the item at time of sale), and/or other information about individual items purchased in the sales transaction. In various examples, the sales transaction data may be linked to the individual item data.

The return system 112 may generally be a computing device including memory storing instructions which, when executed by processors of the return system 112, cause the return system 112 to initiate an item return. For example, the return system 112 may include a barcode or other scanner for scanning barcodes of items being returned and/or receipts received by a customer 104 at the time of purchase of an item. The return system 112 may further include means (e.g., a touchscreen or keyboard) for manual entry of item identifiers and/or information about the sales transaction. In some examples, such interfaces may further be utilized to query the transaction management system 102 for information about a purchased item and/or a sales transaction (e.g., when no receipt is provided for a return). After initiation of a return transaction for an item, the return system 112 communicates return information to the transaction management system 102 through the back-end interface 116. Return information may include, in various examples, any type of sales transaction data associated with a purchase of the item, return date, and the like. The return system 112 may receive from the transaction management system 102, data to complete the return, such as amount of an applied coupon, an indication of whether the return is allowable, payment method for refund, and the like. The return system 112 may complete the return by, in various examples, providing a return receipt to the customer 104, refunding the payment method, and performing other tasks to finalize the return.

After initiation of a sales transaction at the point of sale 108, sale validation 118 generally receives sales transaction data and accompanying item data for items in the sales transaction and, using data 120, publishes the completed sale to order management 122. For example, sale validation 118 may provide a file for a sale receipt with an applied manufacturer coupon to order management 122. Sale validation 118 may further analyze coupon information to determine whether a coupon provided with the sales transaction is applicable to one or more items in the sales transaction. For example, analyzing the coupon information may include comparing items to which the coupon is applicable to items included in the sales transaction, comparing an expiration date of the coupon to the date of the sales transaction, and the like. In some examples, where a coupon cannot be applied to any items in a sales transaction (e.g., the coupon is expired or no items qualifying for the coupon are included in the sales transaction), sale validation 118 may return a message or other notification to the point of sale 108 that the coupon cannot be applied to any items in the sales transaction. Upon determining that the coupon is applicable to one or more items in the sales transaction, sale validation 118 may apply the coupon (or a portion of the coupon) to one or more items in the sales transaction. Sale validation 118 may generally process the transaction in real-time. That is, sale validation 118 may validate the applicability of a coupon while the sales transaction is occurring, such that the customer is provided with the tender and resulting price reduction during the sales transaction.

When a manufacturer coupon is applied to an item, the sale receipt may reflect the amount of the applied coupon, which may be, in some examples, a prorated amount spread or applied across several items purchased in the sales transaction (e.g., when a coupon applies after purchasing a certain number of items). After receiving the sales transaction receipt, order management 122 generally processes the sales transaction and creates an invoice and an official receipt for the sales transaction. The official receipt and the invoice may each reflect that a manufacturer coupon has been applied to one or more items in the sales transaction. Order management 122 may then provide the official receipt and/or the invoice to the sales transaction database 128 and receipt processing 124.

The sales transaction database 128 may generally store sales transaction data which may, in some examples, be associated with a particular customer 104 or customer profile. Sales transaction data may include, in various examples, the official receipt and/or invoice for the sales transaction. The sales transaction data generally includes item entries for each item purchased in a sales transaction. An item entry may generally include an item identifier and data about a coupon or portion of a coupon (if any) applied to the item at purchase. As the sales transaction database 128 is accessible by multiple components of the transaction management system 102, the coupon information associated with individual item entries may be written to the sales transaction database 128 during the initial sales transaction and may be accessed by other components of the transaction management system 102 on return of a particular item, allowing for customer refunds to be processed accurately by refunding the customer 104 the actual amount paid for an item after application of a manufacturer coupon.

Order management 122 may further provide the official receipt and/or invoice to receipt processing 124. Receipt processing 124 generally processes the official receipt and forwards data from the official receipt to a settlement system 134. The settlement system 134 may generally communicate the applied coupon amount to a manufacturer system 110. The manufacturer system 110 may then reimburse the retailer for the amount of the applied coupon and this amount may be tendered to the customer 104 during the sales transaction.

Return validation 130 may generally receive a return request from a return system 112. The return request may include, for example, an item identifier, sales transaction data (e.g., date of purchase, customer identifier, and the like), or other information about the item or the sales transaction including the item. Return validation 130 may utilize return data 132 to determine that the item is eligible for return. For example, return data 132 may include various validation requirements. Validation requirements may include, for example, time limits on item returns, particular items that are not eligible for return, identifiers for items that have already been returned (e.g., receipts associated with returned items), and the like. Return validation 130 may further communicate with the sales transaction database 128 and order management 126 to, for example, validate a return receipt, process a return without a receipt (e.g., by using a customer identifier or other method of identifying the transaction), and perform other functions for validate a return. In various examples, where a return is not possible, return validation 130 may communicate a message to the return system 112 indicating that the item is not returnable.

Where an item is returnable, return validation 130 may communicate the return request to order management 126. Order management 126 may generally communicate with the sales transaction database 128 to access an item entry for the item being returned. The item entry generally indicates whether a coupon was applied to the item during the sales transaction and, if so, additional information about the coupon such as the coupon amount applied to the item, the manufacturer associated with the coupon, and the like. Order management 126 may then communicate the manufacturer coupon amount to receipt processing 124, which may communicate with the settlement system 134 to refund the coupon amount to the manufacturer system 110. The remainder of the item cost (e.g., the amount paid minus any applied coupons) may then be refunded to the customer 104 via the return system 112.

In some embodiments, various components of the transaction management system 102 may be distributed across various computing resources, such that components of the transaction management system 102 communicate with one another through a network and/or using other communications protocols. For example, in some embodiments, the transaction management system 102 may be implemented as a serverless service, where computing resources for various components of the transaction management system 102 may be located across various computing environments (e.g., cloud platforms) and may be reallocated dynamically and/or automatically according to, for example, resource usage of the transaction management system 102. In various implementations, the transaction management system 102 may be implemented using organizational processing constructs such as functions implemented by worker elements allocated with compute resources, containers, virtual machines, and the like.

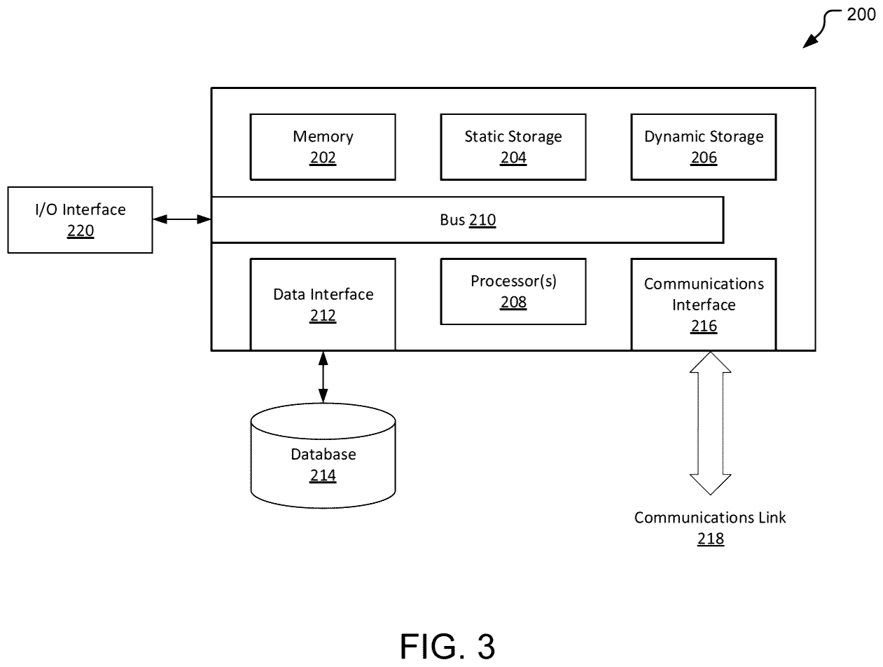

Turning to FIG. 3, an example computing system 200 may be used for implementing various embodiments in the examples described herein. For example, processing and memory resources utilized by the transaction management system 102 may be located at one or several computing systems 200. In various embodiments, the point of sale system 108 and the return system 112 are also implemented by one or more computing systems 200. The transaction management system 102 may also be implemented by one or several computing systems 200. This disclosure contemplates any suitable number of computing systems 200. For example, the a computing system 200 may be a server, a desktop computing system, a mainframe, a mesh of computing systems, a laptop or notebook computing system, a tablet computing system, an embedded computer system, a system-on-chip, a single-board computing system, or a combination of two or more of these. Where appropriate, the computing system 200 may include one or more computing systems; be unitary or distributed; span multiple locations; span multiple locations; span multiple machines; span multiple data centers; or reside in a cloud, which may include one or more cloud components in one or more networks.

Computing system 200 includes a bus 210 (e.g., an address bus and a data bus) or other communication mechanism for communicating information, which interconnects subsystems and devices, such as processor 208, memory 202 (e.g., RAM), static storage 204 (e.g., ROM), dynamic storage 206 (e.g., magnetic or optical), communications interface 216 (e.g., modem, Ethernet card, a network interface controller (NIC) or network adapter for communicating with an Ethernet or other wire-based network, a wireless NIC (WNIC) or wireless adapter for communicating with a wireless network, such as a WI-FI network), input/output (I/O) interface 220 (e.g., keyboard, keypad, mouse, microphone). In particular embodiments, the computing system 200 may include one or more of any such components.

In particular embodiments, processor 208 includes hardware for executing instructions, such as those making up a computer program. The processor 208 circuity includes circuitry for performing various processing functions, such as executing specific software for perform specific calculations or tasks. In particular embodiments, I/O interface 220 includes hardware, software, or both, providing one or more interfaces for communication between computing system 200 and one or more I/O devices. Computing system 200 may include one or more of these I/O devices, where appropriate. One or more of these I/O devices may enable communication between a person and computing system 200.

In particular embodiments, communications interface 216 includes hardware, software, or both providing one or more interfaces for communication (such as, for example, packet-based communication) between computing system 200 and one or more other computer systems or one or more networks. One or more memory buses (which may each include an address bus and a data bus) may couple processor 208 to memory 202. Bus 210 may include one or more memory buses, as described below. In particular embodiments, one or more memory management units (MMUs) reside between processor 208 and memory 202 and facilitate accesses to memory 202 requested by processor 208. In particular embodiments, bus 210 includes hardware, software, or both coupling components of computing system 200 to each other.

According to particular embodiments, computing system 200 performs specific operations by processor 208 executing one or more sequences of one or more instructions contained in memory 202. For example, instructions for the various components of the transaction management system 102 may be contained in memory 202 and may be executed by the processor 208. Such instructions may be read into memory 202 from another computer readable/usable medium, such as static storage 204 or dynamic storage 206. In alternative embodiments, hard-wired circuitry may be used in place of or in combination with software instructions. Thus, particular embodiments are not limited to any specific combination of hardware circuitry and/or software. In various embodiments, the term “logic” means any combination of software or hardware that is used to implement all or part of particular embodiments disclosed herein.

The term “computer readable medium” or “computer usable medium” as used herein refers to any medium that participates in providing instructions to processor 208 for execution. Such a medium may take many forms, including but not limited to, nonvolatile media and volatile media. Non-volatile media includes, for example, optical or magnetic disks, such as static storage 204 or dynamic storage 206. Volatile media includes dynamic memory, such as memory 202.

Computing system 200 may transmit and receive messages, data, and instructions, including program, e.g., application code, through communications link 218 and communications interface 216. Received program code may be executed by processor 208 as it is received, and/or stored in static storage 204 or dynamic storage 206, or other storage for later execution. A database 214 may be used to store data accessible by the computing system 200 by way of data interface 212. For example, data 120, data in the sales transaction database 128, and return data 132 may each be stored using a database 214. In various examples, communications link 218 may communicate with, for example, user devices to display user interfaces to the transaction management system 102.

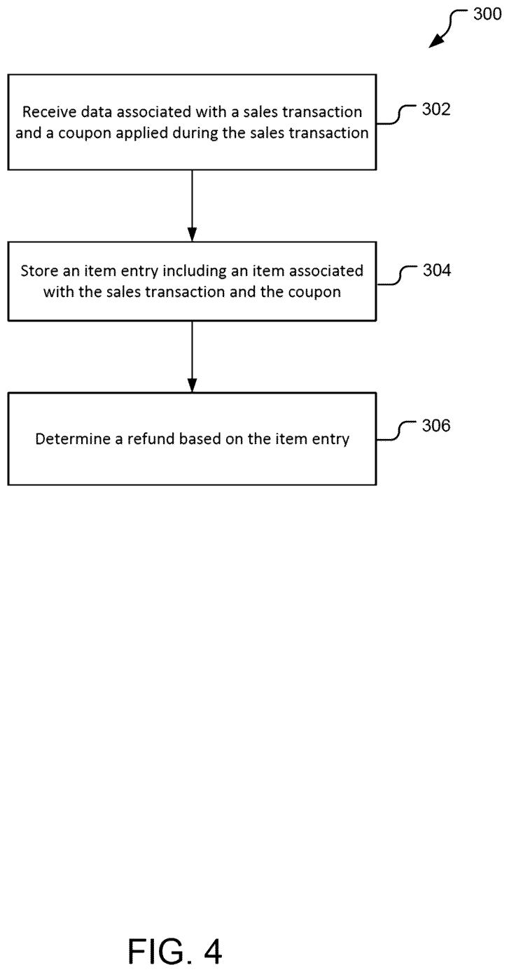

FIG. 4 is a flow diagram of steps 300 for determining a refund for an item purchased with a coupon. At block 302, data is received at the transaction management system 102, where the data is associated with a sales transaction and a coupon applied during the sales transaction. In various examples, such sales transaction data may be received by the transaction management system 102 from a point of sale system 108 used to initiate the sales transaction. The point of sale system 108 may access the transaction management system 102 and/or individual components of the transaction management system using a secured API, via a secured network, or the like. For example, the back-end interface 116 may provide an API for the point of sale system 108 to provide sales data to, and receive information from, sale validation 118. Within the transaction management system 102, sale validation 118 may access order management 122 through an API to order management 122. For example, identifiers of items included in the sales transaction may be provided to the point of sale system 108 (e.g., through scanning or manual entry) and the item identifiers may be part of the sales transaction data. Similarly, coupons applied to items within the sales transaction may be entered into the point of sale system 108.

In some examples, the coupon may be applied during the sales transaction after being separately validated by the transaction management system 102. For example, sale validation 118 may utilize data 120 to determine whether the coupon can be applied to one or more items in the sales transaction. Such a determination may be made using information about the coupon (e.g., items to which the coupon can be applied, expiration date of the coupon, or the like). In such examples, the transaction management system 102 may communicate the determination to the point of sale system 108 during the transaction, such that the coupon amount can be tendered to the customer during the transaction when the coupon can be applied to an item in the order.

An item entry is stored at block 304, where the item entry includes an item associated with the sales transaction and the coupon. The item entry may generally be stored as a row or entry in a database (e.g., the sales transaction database). The item entry generally includes identifying information for the sales transaction, item, customer, and the like. The item entry further includes an indication of whether a coupon was applied to an item during the sales transaction, as well as an amount of the coupon. Conventional storage structures generally include only transaction bulk information and not individual item information. In the transaction management system described herein, because the item entry is stored with identifying information for the transaction and customer, the item entry may be easily located upon return of the item, and the coupon data stored with the item entry may be easily accessed to process the return. Generally, after receiving the sales transaction data and the coupon data, the transaction management system 102 validates the sales transaction, generates receipts, obtains reimbursement from the manufacturer for the coupon amount, and stores the sales transaction data.

A refund is determined based on the item entry at block 306. The refund may be determined responsive to a return request received through a return system 112 at a retailer. Generally, the return request may be a request to return a particular item from a sales transaction. The return request may include an item identifier and/or an identifier for the sales transaction. For example, the return system 112 may scan a barcode or other identifier on a sales transaction receipt to identify the sales transaction when the item was purchased. The return system 112 may then display items purchased in the sales transaction and a user may select the item for return, causing an item identifier to be provided to the transaction management system 102. Other identifiers of the item and/or the sales transaction may be utilized such as a barcode of the item, identification of payment method, customer profile, and the like.

Upon receiving the return request, the transaction management system 102 may first verify that return of the item is permissible. Return validation 130 may utilize the sales transaction data, item data, and/or return data 132 to verify that the selected item can be returned. For example, return validation 130 may utilize the item identifier received with the return request to determine, using return data 132, whether the item itself is returnable. Return validation 130 may, in some examples, utilize additional sales transaction and/or item data, such as date of purchase, to determine whether an item is returnable.

The transaction management system 102 may further determine that a coupon is associated with the item. In various examples, order management 126 may access the item entry at the sales transaction database 128 to determine whether the item was purchased using a manufacturer coupon. For example, the item identifier and/or sales transaction identifier obtained with the return request may be utilized to look up the item entry corresponding to the item and the sales transaction in the sales transaction database 128. Where the item was purchased with a manufacturer coupon, such information is included in the item entry (e.g., stored in the item entry at purchase of the coupon). Accordingly, the transaction management system 102 is able to determine, at the time of return, that the item was purchased using a coupon. The item entry may further include an amount of the coupon and an initial amount paid by the customer. For example, the amount paid by the customer may be defined as the purchase price (including surcharges such as sales tax) minus the amount of the coupon.

In various examples, after determining the return amount, the transaction management system 102 may refund the customer the purchase price of the item and refund the manufacturer the coupon amount. For example, the transaction management system 102 may provide the refund amount to the return system 112, and the return system 112 may generate a return receipt reflecting the total refund due to the customer, accounting for the manufacturer coupon applied at the time of purchase. The transaction management system 102 may further interface with a manufacturer system 110 to refund to the manufacturer the coupon amount applied to the item at purchase.

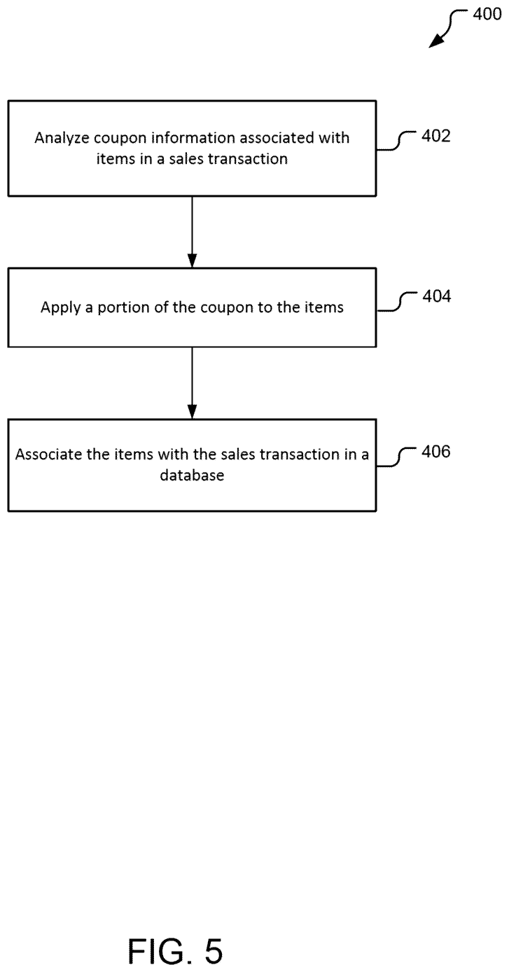

FIG. 5 is a flow diagram of steps 400 for storing coupon information associated with a sales transaction. At block 402, coupon information is analyzed, where the coupon information is associated with items in a sales transaction. A coupon may be associated with multiple items in a sales transaction, such as a buy one get one free offer or a coupon for a dollar amount off when a number of the same item is purchased. For example, a coupon may provide one dollar off when ten of the same item is purchased in a single sales transaction.

Analyzing the coupon information may include verifying that the coupon can be applied to the items in the sales transaction. For example, sale validation 118 may compare items to which a coupon is applicable to items in the sales transaction, compare an expiration date of the coupon to the date of the sales transaction, and the like. In various examples, where the coupon is only applicable when a certain number of items are purchased, analyzing the coupon information may further include verifying that the number of items purchased in the sales transaction match the conditions of the coupon. The coupon may be analyzed during the sales transaction, such that the tender may be provided to the customer in real-time, enhancing customer service.

Analyzing the coupon information may further include determining a portion of the coupon to apply to the items in the sales transaction. In various examples, the coupon may be prorated across multiple items in a sales transaction. For example, a coupon may provide a dollar reduction in price when ten identical items are purchased in a sales transaction, and a ten-cent tender may be provided for each item rather than providing a dollar tender towards one of the ten items.

A portion of the coupon is applied to the items at block 404. In various examples, applying the coupon includes tendering the portion of the coupon applied to the items to the customer. For example, the transaction management system 102 may communicate the amount of the coupon applied to the items to the point of sale system 108, and the point of sale system 108 may provide the amount to the customer as a tender. Accordingly, the customer purchases the items for the purchase price of the items less the amount of the coupon. For example, where a total purchase price for items is $14.99, including taxes and other fees, and the coupon amount is $3.00, the point of sale system 108 completes the purchase with the customer paying $11.99 for the items.

At block 406, the items are associated with the sales transaction in a database. The database is generally located at the transaction management system 102. For example, the database may be the sales transaction database 128. Generally, each of the items may be associated with an item entry, and each of the item entries may be associated with the sales transaction at the sales transaction database 128. The sales transaction may be stored with various data or information about the sales transaction including, for example, items purchased, date of the sales transaction, location of the sales transaction, method of payment, customer profile associated with the sales transaction, items purchased in the sales transaction, and the like. The item entries may include information about items purchased in the sales transaction, including the portion of the coupon applied to the items in the sales transaction. In some examples, additional coupon information may be stored with the item entries, such as a manufacturer associated with the coupon, expiration date of the coupon, total value of the coupon, and the like.

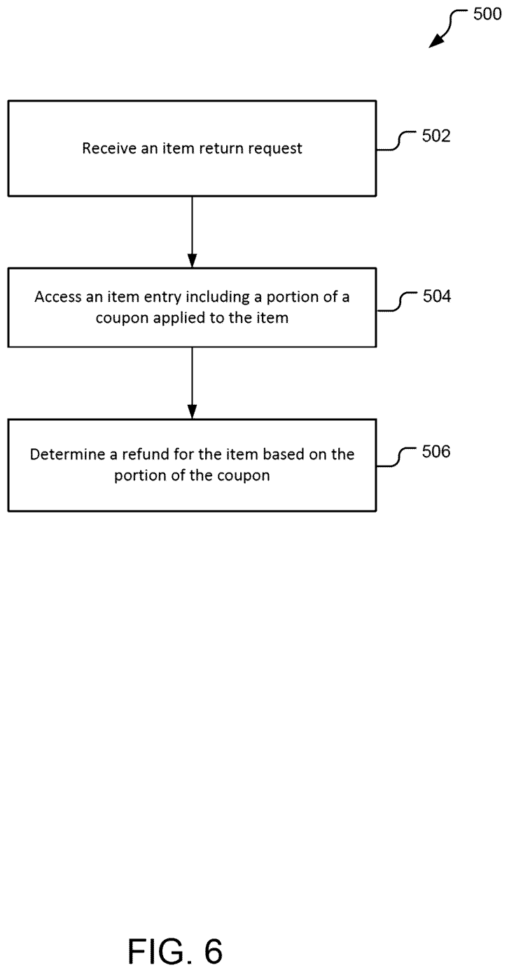

FIG. 6 is a flow diagram of steps 500 for determining a refund for an item based on stored coupon information associated with a sales transaction. At block 502, an item return request is received. The item return request may be received from a point of sale system 108 in communication with the transaction management system 102. For example, a customer at a retail location may request to return an item purchased with a manufacturer coupon. In various examples, the item return request may include an identifier of a sales transaction when the item was purchased, an item identifier, or other information or data used to identify the sales transaction and/or the item being returned.

An item entry is accessed at block 504, where the item entry includes a portion of a coupon applied to the item. In various examples, the transaction management system 102 (e.g., return validation 130) may determine that the item is returnable upon receipt of the item return request based on various validation requirements. For example, return validation 130 may utilize return data 132 to determine whether the item is within a return window, is a returnable item, or similar. Upon determining that the item is returnable, the item entry may be accessed using information received with the item return request. For example, the item return request may include an identifier of the item and an identifier of the sales transaction, which may be utilized to locate the item entry in the sales transaction database 128.

At block 506, a refund is determined for the item based on the portion of the coupon. For example, a refund may be an amount paid by the customer at purchase of the item. In some examples, the refund may be based on a full purchase price of the item (e.g., including the amount tendered to the customer from use of the coupon) less the portion of the coupon applied to the item. In various examples, the transaction management system 102 may communicate with the return system 112 to provide the refund amount to the customer 104.

The transaction management system 102 described provides for improved retail returns for items purchased with manufacturer coupons. For example, the transaction management system stores information about manufacturer coupons with initial transaction data at the time of purchase. Because the transaction management system 102 is in communication with both a point of sale system 108 and the return system 112, such information is also accessible at the time of return, such that the return can be properly processed with the customer receiving a refund for the amount paid at purchase of the item and the manufacturer receiving a refund for the coupon amount tendered at purchase of the item.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of the invention as defined in the claims. Although various embodiments of the claimed invention have been described above with a certain degree of particularity, or with reference to one or more individual embodiments, it is appreciated that numerous alterations to the disclosed embodiments without departing from the spirit or scope of the claimed invention may be possible. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A computer implemented method for retail sales comprising:
analyzing coupon information associated with one or more items in a sales transaction to confirm the coupon is usable in the sales transaction;
applying a portion of the coupon to the one or more items;
receiving data associated with the sales transaction and the coupon, the data comprising a customer identifier, a price and an item identifier for each of one or more items purchased, a transaction identifier, an indication of use of the coupon and coupon information associated with the coupon;
storing the data as an entry in a database, the entry linking the transaction identifier to the customer identifier and to each item identifier;
responsively transmitting, to a manufacturer system, a request for reimbursement for the portion of the coupon applied to the one or more items;
receiving the transaction identifier;
responsively transmitting, to a computing device, a user interface to display the one or more items associated with the transaction identifier;
receiving, from the computing device, a selection of at least one item to be returned, the selection comprising a return request that includes the item identifier for the at least one item and the customer identifier;
retrieving, from the database, the item entry based on the item identifier associated with the at least one item and the customer identifier in the return request;
based on the item entry, including the indication of the use of the coupon and the coupon information, determining a first refund for the at least one item including the portion of the coupon applied to the one or more items; and
responsive to determining the first refund, transmitting, to the manufacturer system, a second refund for the portion of the coupon applied to the one or more items.

2. The computer implemented method of claim 1, wherein analyzing the coupon information comprises determining the portion of the coupon to apply to the one or more items.

3. The computer implemented method of claim 1, wherein the one or more items includes a plurality of items, wherein coupon information comprises an indicator that the coupon is applicable to each of the plurality of the one or more items in the sales transaction.

4. The computer implemented method of claim 3, wherein applying the portion of the coupon to the one or more items comprises applying the portion of the coupon to each of the plurality of the one or more items.

5. The computer implemented method of claim 1, wherein the first refund is a purchase price of the one or more items less the portion of the coupon applied to the one or more items.

6. (canceled)

7. (canceled)

8. A transaction management system comprising:
an interface in communication with a point of sale system associated with a retailer, wherein the interface is configured to receive data associated with a sales transaction and a coupon applied during the sales transaction;
a sales transaction database configured to store an item entry, wherein the item entry comprises the coupon, a customer identifier, a price and an item identifier for at least one item associated with the sales transaction, a transaction identifier, and an indication of use of the coupon;
a return validation system in communication with a return system associated with the retailer, wherein the return validation system is configured to determine a first refund based on the item entry stored in the sales transaction database; and
a settlement system in communication with a manufacturer system associated with the at least one item, wherein the settlement system is configured to provide a request for reimbursement to the manufacturer system for an amount of the coupon applied during the sales transaction and, responsive to the first refund, transmit a second refund to the manufacturer system for the amount of the coupon applied during the sales transaction.

9. The transaction management system of claim 8, wherein the transaction management system further comprises a sale validation system configured to analyze the data associated with the coupon and apply the coupon to the at least one item during the sales transaction.

10. The transaction management system of claim 8, wherein the first refund is a purchase price of the at least one item less a value of the coupon applied to the at least one item.

11. (canceled)

12. The transaction management system of claim 8, wherein the return validation system is further configured to communicate the first refund to the return system.

13. The transaction management system of claim 8, wherein the at least one item includes a plurality of items, wherein the item entry comprises an indicator that a portion of the coupon was applied to each of the plurality of items during the sales transaction.

14. The transaction management system of claim 13, wherein the first refund is based on the portion of the coupon applied to an item of the plurality of items.

15. One or more non-transitory computer readable media encoded with instructions which, when executed by one or more processors, cause the one or more processors to:
receive, from a point of sale system associated with a retailer, data associated with a sales transaction and a coupon applied during the sales transaction, the data comprising a customer identifier, a price and an item identifier for an item associated with the sales transaction, a transaction identifier, and an indication of use of the coupon;
transmit, to a manufacturer system, a request for reimbursement for an amount of the coupon applied to the item;
store an item entry in a database, wherein the item entry comprises the data associated with the sales transaction, the item entry linking the transaction identifier to the customer identifier and to the item identifier;
receive the transaction identifier;
responsively transmit, to a computing device, a user interface to display the item associated with the transaction identifier;
receive, from the computing device, a selection of the item to be returned, the selection comprising a return request that includes the item identifier for the item and the customer identifier;
retrieve, from the database, the item entry based on the item identifier associated with the item and the customer identifier in the return request;
based on the item entry, including the indication of the use of the coupon and the coupon information, determine a first refund for the item;
communicate the first refund to a return system associated with the retailer; and
responsive to determining the first refund, transmit, to the manufacturer system, a second refund for the amount of the coupon applied to the item.

16. (canceled)

17. The one or more non-transitory computer readable media of claim 15, wherein:
the sales transaction is associated with a plurality of items; and
a portion of a value of the coupon is applied to each of the plurality of items during the sales transaction.

18. The one or more non-transitory computer readable media of claim 17, wherein the first refund is determined further based on the portion of the value of the coupon applied to an item of the plurality of items.

19. (canceled)

20. (canceled)
